(19) United States
(12) Patent Application Publication
(10) Pub. No.: US 2005/0025293 A1
(43) Pub. Date: Feb. 3, 2005

(54) Calling card access to internet portal using interactive voice response (IVR) system

(75) Inventors: John P. Romeo, Austin, TX (US); David W. Rackley, Austin, TX (US)

Correspondence Address: BAKER BOTTS L.L.P.;PATENT DEPARTMENT, 98 SAN JACINTO BLVD., SUITE 1500, AUSTIN, TX, 78701-4039, US

(73) Assignee: SBC Knowledge Ventures, L.P., Reno, NV (US)

(21) Appl. No.: 10/633,356

(22) Filed: Aug. 1, 2003

(51) Int. Cl. H04M 1/64; H04M 11/00

(52) U.S. Cl. 379/88.17; 379/88.18

(57) ABSTRACT

A calling card service that optionally provides access to an Internet portal. The customer dials the calling card number and selects between normal telephone 5 service or portal access. If the customer selects portal access, an IVR system is used to guide the customer to the desired information, which is translated from text to voice so that the customer may listen to an audio version of the Internet content.

### TECHNICAL FIELD OF THE INVENTION

This invention relates to telephonic communications systems, and more particularly to a method of accessing an Internet portal site using a calling card number and an interactive voice response (IVR) system.

### BACKGROUND OF THE INVENTION

Internet service providers (ISPs) often provide their customers with a portal, which offers a broad array of resources and services, such as links to e-mail, forums, search engines, and on-line shopping. The portal content is typically in extensible markup language (XML) format, and is accessed via an Internet connection.

From the basic concept of providing a portal, has evolved the concept of providing individualized content in the portal. In other words, many ISPs provide a basic portal format, and also permit each customer to select preferences for his or her portal content, such as selecting certain news, sports, or stock quotes of interest to that customer. Thus, the various customers use the same basic portal format but with individualized features.

### BRIEF DESCRIPTION OF THE DRAWINGS

FIG. 1 illustrates a calling card portal system in accordance with the invention.

FIG. 2 illustrates a method of using the calling card portal system of FIG. 1.

### DETAILED DESCRIPTION OF THE INVENTION

The following description is directed to a method of using a modem-less telephony network to access a customer's Internet portal. In other words, the method provides an ISP subscriber with a second method for accessing an Internet, via a telephone needing no Internet-enabled features.

The customer accesses his or her existing portal, using a calling card number, and interacts with the portal using interactive voice response (IVR) technology.

For purposes of this description, a “calling card number” is an identifying number or code unique to an individual, that is issued to the individual by a common carrier and enables the individual to be charged for placing phone calls, independent of where the call originates. Calling cards are familiar in the form of credit card sized plastic cards. A feature of a calling card is that charges are incurred on a “per use” basis.

IVR systems are systems that provide information in the form of audio messages over telephone lines. These systems can provide audio responses to customer input, where the input may be in the form of spoken words or touch tone signaling. IVR dialogs are “automated” with respect to both input from, and output to, the customer.

For purposes of this invention, output directed to the customer may be in the form of either audio prompts or audio Internet content. Prompts are typically in the form of recorded menu type selection choices, but may be in the form of any type of prompt for interactive customer responses. The customer responses may be entered by touch tone, by voice recognition, TTY, some other type of telephone key pad, or some combination of these, collectively referred to herein as “IVR input”.

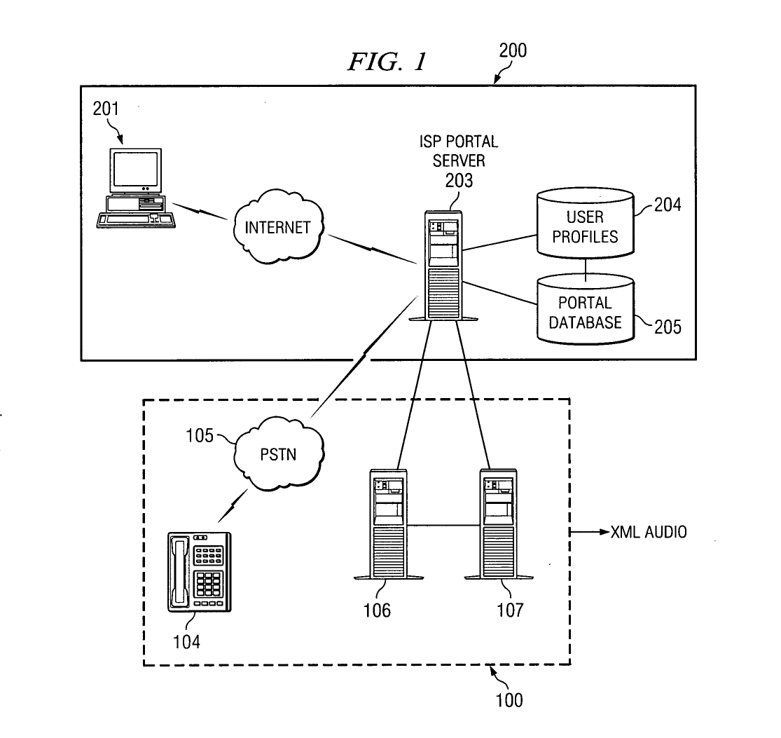

FIG. 1 illustrates a calling card portal system 100 in accordance with the invention. System 100 is used in conjunction with an Internet portal system 200.

Internet portal system 200 may be implemented with network equipment available today or to be developed. A customer with a personal computer 201 subscribes to an Internet Service Provider (ISP), whose servers and other computing and data storage equipment provide Internet access. The Internet access from the computer 201 may be by dial-up, broadband, wireless, or by means of any other type of Internet link.

It is assumed that the ISP server 203 provides a portal, accessible via a web browser of the personal computer 201. When the customer goes on-line, the portal is displayed on the display of the customer's computer 201.

For purposes of this invention, a “portal” is a site featuring a suite of commonly used services, serving as a starting point and frequent gateway to the Web (Web portal). Typically, the portal is presented as a single web page. Web portal services often include a search engine or directory, news, email, stock quotes, maps, forums, chat, shopping, and options for customization. These are only some of the most frequently offered services; large portals often include dozens or hundreds of bundled services. Portals also serve as destinations for advertisers and marketers, offering a endless variety of choices. Examples of portal access formats are banners, buttons, and text links & search results. A web portal is sometimes referred to as a gateway.

The ISP provides appropriate server equipment 203 for Internet access to portal database 205. The portal content is derived from this database 205. The data in database 205 is stored in an Internet compatible format, such as XML (extensible markup language).

As indicated in the Background, a feature of most portals is the ability of the user to customize the portal contents. For example, the customer may select preferences for topics such as regional sports or weather, or certain stock listings. A user's set of preference selections (or a default configuration) determines how the Internet portal will be displayed on the user's computer 201. As explained below, the user may also select preferences for how his or her portal will presented in audio form when he or she accesses the portal via the IVR system 106.

A customer may have the same preferences for both Interent and calling card access to the portal, with settings made using one form of access being effective when access is accomplished using the other form of access. Alternatively, the user could be permitted to have different preferences, depending on whether the access is via the Internet or via a calling card.

The selection of preferences by a user determines how the portal is presented, or in other words, what content is available to the user. The preferences remain the same until the preferences are changed. The selection of preferences for all accesses is in contrast to the selection of particular content each time the portal is accessed.

The customization feature is useful, but not necessary to the present invention. If the ISP does provide portal customization, the ISP 203 collects preference data from each customer, which determines how each customer's portal is to be customized. If the customer has customized the portal server 203 by entering content preferences, the preferences are stored in a user profiles database 204. A user's set of preferences is referred to as a “profile” for that user. Database 204 also stores each customer's password, whose function is explained below.

Calling card portal system 100 comprises a telephone 104, which the customer uses to access the ISP server 203 via the PSTN (public switched telephone network). The customer may use any telephone at any location, wired or wireless. No special Internet-enabled telephone equipment is required. The customer gains this access by dialing a calling card number.

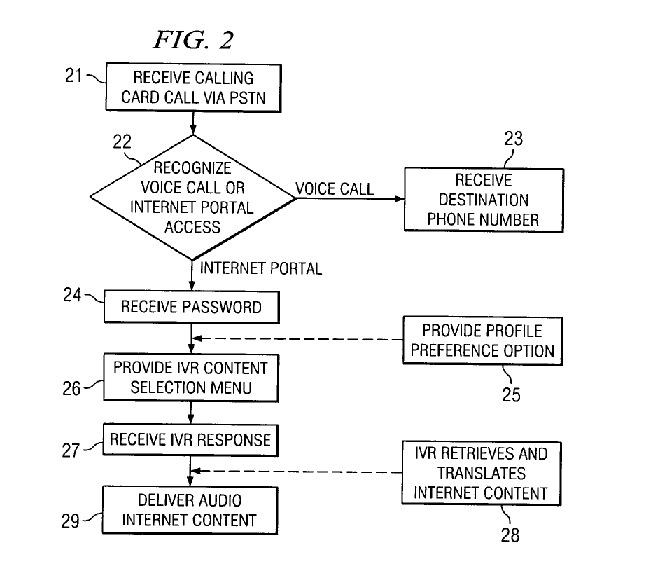

FIG. 2 illustrates a method of using the calling card portal system of FIG. 1. FIG. 2 illustrates the method from the point of view of the calling card portal system 100, but also implies a method of using the system 100 from the point of view of the user.

In Step 21, to access his or her portal in accordance with the invention, the customer dials a calling card access number to connect to the public switched telephone network (PSTN) 105. Each calling card has an associated password, which is keyed to the customer's Internet portal.

The calling card issuer may be, but is not necessarily, the same entity as the ISP. Many of today's telephone service providers provide both calling card and ISP services, but it is also possible that a calling card issuer could arrange for a PSTN connection to an ISP, in the manner described herein.

Upon dialing the calling card access number, a telephonic connection is made to IVR server 106. No modem is required for the connection.

In Step 22, IVR server 106 presents the customer with two choices: to make a telephone call or to access the portal. IVR system 106 is capable of recognizing DTMF key input or voice input, with the choice of input typically being the customer's option.

IVR server 106 may present the choice of phone call versus Internet portal access in any number of ways. For example, the choice could be presented as “Dial 1 to make a call, Dial 2 for your Internet portal”. Or, as another example, the default mode could be making calls, and the customer could simply enter his or her password to obtain Internet access.

In Step 23, if the customer desires to make a telephone call, the customer simply dials the telephone number.

In Step 24, if the customer desires to access the portal, the customer enters his or her password, which may be accomplished by entering a key code or by voice.

In Step 25, IVR system presents the user with an option to change his or her preferences. As indicated above, a user profiles database 204 stores the user's preferences for the user's customized portal. A feature of the invention, is that IVR server 106 may be programmed to present the user with a menu or other means for altering his or her portal preferences. The user responds with IVR input, resulting in a change to the data stored in database 204. Thus, a customer may alter his or her profile using IVR through the calling card portal or on-line through the Internet portal. Step 25 may be performed at any time during the calling card connection. Any number of IVR techniques, including menus and other prompts, may be used to elicit preference selections, and the user may use various IVR inputs to make preference settings.

In Step 26, IVR system 106 provides a menu of content choices. Examples of content are email, stock quotes, and news or weather information. The content selection menu may be audio or for telephones with displays, may be in text format. In some embodiments, it may be that the content selection menu is standardized or otherwise known, such that a menu is not required, and the user simply knows what input to provide for content selection. The term “menu” is used herein in its broadest sense, to mean any audio means for indicating that the user may choose among available items.

In Step 27, the customer responds to the menu selection. In Step 28, IVR system 106 finds the desired information and delivers it to text-to-speech translator 107. It is assumed that IVR system 106 is capable of recognizing and transmitting data in the same format as used for Internet downloading. To accomplish Step 27, IVR system 106 instructs ISP server 203 to retrieve the information. Thus, IVR system 106 includes programming appropriate for converting the customer input (representing content selection) to instructions intelligible by ISP server 203.

In Step 29, translator 107 translates the selected content to an audio data stream for delivery to the customer. For example, if database 205 stores data in an XML format, the translation is from XML text to audio. The translation techniques may vary depending on the content. Methods for translating email to voice are familiar today.

The method and system described above expand Internet information to existing markets, both wire line and wireless telephony access, on a pay-per-use basis. Customers will be able to receive the same customized Internet portal information as is available through Internet access, but as a feature of a calling card service.

### OTHER EMBODIMENTS

Although the present invention has been described in detail, it should be understood that various changes, substitutions, and alterations can be made hereto without departing from the spirit and scope of the invention as defined by the appended claims.

1. A method of providing a user with access to the content of an Internet portal, using the public switched telephone network (PSTN) and a modemless connection, comprising the steps of:
receiving, at an interactive voice response (IVR) system, a telephone call from the user, dialed with a calling card number and incoming through the PSTN;
recognizing IVR input from the user to select between a voice call and Internet portal access;
for a voice call, completing the telephone call to a destination telephone number;
for Internet portal access, performing the following steps: receiving IVR input from the user representing a password; providing the user with a preference selection menu; providing the user with a content selection menu; receiving IVR input from the user representing Internet content selection; communicating the content selection to an Internet server; translating the Internet content from text format to audio data; and
transmitting the audio data to the user via the PSTN.

2. A method of providing a user with access to the content of an Internet portal, using the public switched telephone network (PSTN) and a modemless connection, comprising the steps of:
receiving, at an interactive voice response (IVR) system, a telephone call from the user, dialed with a calling card number and incoming through the PSTN;
recognizing IVR input from the user to select between a voice call and Internet portal access;
for a voice call, completing the telephone call to a destination telephone number;
for Internet portal access, performing the following steps: receiving IVR input from the user representing a password; communicating content instructions to an Internet server; translating the Internet content from text format to audio data; and
transmitting the audio data to the user via the PSTN.

3. The method of claim 2, wherein the receiving step is performed with a wire line call from the user.

4. The method of claim 2, wherein the receiving step is performed with a wireless call from the user.

5. The method of claim 2, wherein the text format is XML format.

6. The method of claim 2, wherein the IVR input is telephone keypad input.

7. The method of claim 2, wherein the IVR input is voice input.

8. The method of claim 2, wherein for Internet portal access, the step of receiving IVR input is followed by the steps of providing an IVR menu of Internet content selections and of receiving IVR input representing an Internet content selection.

9. The method of claim 2, wherein the Internet content is email messages.

10. The method of claim 2, further comprising the steps of presenting the user with an option to change portal preferences and of receiving IVR input representing one or more preference settings.

11. A system for accessing the content of an Internet portal database served by a portal server, using the public switched telephone network and a modemless connection, comprising:
a text-to-speech translator for receiving Internet content from the Internet portal database and for translating text representing the Internet content to audio data; and
a interactive voice response (IVR) system operable to receive an incoming calling card call via the public switched telephone network (PSTN), to recognize whether the call is to be completed as a telephone call or for access to the Internet content, and to instruct the portal server to retrieve the Internet content and deliver the Internet content to the text-to-speech translator.

12. The system of claim 11, wherein the IVR system is operable to receive the calling card call from a wire line telephone.

13. The system of claim 11, wherein the IVR system is operable to receive the calling card call from a wireless telephone.

14. The system of claim 11, wherein the text-to-speech translator translates text in XML format to audio data.

15. The system of claim 11, wherein the IVR system is further operable to provide menu selections representing Internet content selections.

16. The system of claim 11, wherein the IVR system is further operable to receive IVR input representing Internet content selections.

17. The system of claim 11, wherein the IVR system is further operable to receive IVR input representing portal preferences and to communicate data representing the preferences to the portal server.

18. The system of claim 11, wherein the IVR input is telephone key input.

19. The system of claim 11, wherein the IVR input is voice input.

20. A method of providing a user with access to an Internet portal, comprising the steps of:
providing the user with access to the portal via the Internet;
providing the user with access to the same portal content via a calling card number placed on the public switched telephone network (PSTN);
providing means for receiving user input representing preference selections via the Internet; and
providing means for receiving user input representing preference selections via a calling card call on the PSTN.
